(19) United States
(12) Patent Application Publication
(10) Pub. No.: US 2019/0355061 A1
(43) Pub. Date: Nov. 21, 2019

(54) SYSTEM AND METHOD FOR DETERMINING RISK OF AN INVESTMENT

(71) Applicant: Cesar Ramos, Park City, UT (US)

(72) Inventor: Cesar Ramos, Park City, UT (US)

(21) Appl. No.: 16/412,415

(22) Filed: May 15, 2019

Related U.S. Application Data
(60) Provisional application No. 62/672,051, filed on May 16, 2018.

(51) Int. Cl. G06Q 40/04

(52) U.S. Cl. CPC G06Q 40/04

(57) ABSTRACT

A system and method for determining risk of a potential investment comprises determining a maximum amount of risk per trade based on an initial capital contribution, a risk level, a savings percentage, and a number of trades allowed per day. A potential risk of an investment may be calculated based on the maximum amount of risk, a predetermined number of trades allowed per day, a predetermined entry, and a predetermined protective stop. Where the potential risk of the investment is less than the maximum amount of risk, the process or system may advise to execute the trade. Where the potential risk is greater than the maximum amount of risk, the process or system may advise against executing the trade.

### TECHNICAL FIELD

This disclosure relates generally to the field of risk management in investment trading. More particularly, the disclosure relates to systems and processes for determining risk and minimizing risk.

### BACKGROUND

In trading, risk management is one of the most crucial points of every single trade. Traders use various calculations and models in order to protect investments and also maximize returns. Determining an entry point, a stop, etc., are important to ensure gains and protect from losses. However, it is not possible to achieve any gains without also risking. Thus, determining an appropriate level of risk can help an investor or trader determine if a potential investment should be pursued.

Currently, many risk managers use formulas to determine risk of an investment for a client and based on the outcome of the formula, they may advise to execute a particular trade. For example, standard deviation, beta, value at risk, and conditional value at risk are all common methods of calculating risk. However, there is no current equation that takes into account fully an investor's appetite for risk (which is typically based on their age and other circumstances), including their acceptable risk level, capital contribution, and savings percentage, along with the maximum amount of risk, a predetermined number of trades allowed per day, a predetermined entry, and a predetermined protective stop. It may be advantageous for a risk manager and/or trader to have a single equation that takes into consideration these multiple variables to allow them to make more accurate decisions on when to execute a trade. It also may advantageously prevent traders from executing a trade based on extrinsic factors such as emotions, etc.

### SUMMARY

According to one aspect, a process for determining potential risk of a potential investment/trade is disclosed. The process may be performed by a system. According to one aspect, the system may calculate a maximum amount of risk based on an initial capital contribution, a predetermined savings percentage, and a risk level.

According to another aspect, the system may calculate a potential risk for a potential trade of a security having a price, wherein the potential risk for the potential trade is calculated based on the maximum amount of risk, a predetermined number of trades allowed per day, a predetermined entry, and a predetermined protective stop.

According to another aspect, the system may compare the maximum amount of risk to the potential risk for the potential trade. When the maximum amount of risk is less than the risk for the potential trade, the system may send a message to execute the trade. In other configurations, the system may be in communication with a third party system, and the system may execute the trade automatically based on the calculated risk.

Calculating maximum amount of risk may comprise calculating the maximum amount of risk based on a total purchasing power, taking into consideration trading on margin and/or leverage available. Calculating the maximum amount of risk may comprise multiplying the total purchasing power by 100 percent minus the predetermined savings percentage, and multiplying the total purchasing power by the risk level.

According to one aspect, the predetermined savings percentage may be any suitable percentage preselected by an investor. In some configurations, no savings will be made and the system will not save a portion of the initial capital, but will use the entire amount of initial capital in the risk calculations.

The potential risk of an investment may be calculated according to the following equation:

$$Potential Risk = ( \frac{Maximum Amount Per Trade}{Price} ) \times ( Entry - Protective Stop )$$

According to another aspect, the system may use the calculated potential risk of an investment, and the calculated maximum amount of risk allowed, and compare in order to recommend or not recommend a trade. The system may use the following equation to determine whether to recommend a trade:

$$Risk Trading Model = ( \frac{Maximum Amount Per Trade}{Price} ) \times Pip Risk \leq Total Purchasing Power \times ( 100 \% - Savings \% ) \times RiskLevel$$

According to another aspect, a process is described for determining the risk of a security, the process comprising the steps of: inputting, by a user, an initial capital contribution, a risk level, and a savings percentage; inputting, by a user, a protective stop, an entry price, a rate, and an exit; calculating, by a risk management calculator, a maximum amount of risk based on the initial capital contribution, the risk level, and the savings percentage; calculating, by a potential risk calculator, a potential risk for the security, based on the protective stop, the entry price, the rate, and the exit.

The process may further comprise inputting a leverage. In some configurations, the user may input the name or other identifier of a potential investment, and the system may be configured to retrieve data associated with the potential investment, such as the current price, etc.

A computer program product may be configured to execute the steps associated with the product, and comprise, for example: computer-executable instructions for calculating a maximum amount of risk based on an input of initial capital contribution, a predetermined savings percentage, and total purchasing power; computer-executable instructions for calculating a risk for a potential trade of a security having a price, the code for calculating the risk for the potential trade of the security calculating the risk for the potential trade of the security based on the initial capital contribution, the predetermined savings percentage, a predetermined number of trades allowed per day, the price of the security, and a predetermined protective stop; computer-executable instructions for comparing the maximum amount of risk to the risk for the potential trade; and computer-executable instructions for outputting an instruction to execute the potential trade when the maximum amount of risk is greater than the risk for the potential trade.

### BRIEF DESCRIPTION OF THE DRAWINGS

The following drawings illustrate what are currently considered to be specific representative configurations for carrying out the invention and are not limiting as to embodiments which may be made in accordance with the present invention. Like reference numerals designate corresponding parts throughout the several views.

The drawings are illustrative and not limiting of the scope of the invention which is defined by the appended claims. The various elements of the invention accomplish various aspects and objects of the invention. Not every element of the invention can be clearly displayed in a single drawing, and as such not every drawing shows each element of the invention.

FIG. 1 shows a system for receiving inputs and for determining a maximum risk amount based on the received inputs.

FIG. 2 shows a system for receiving inputs and for determining a maximum risk amount per trade based on the received inputs.

FIG. 3 shows a system for receiving inputs and for determining a potential risk for a potential trade based on the received inputs.

FIGS. 4-7 show example inputs into the systems of FIGS. 1-3, and results of the calculations performed by the system.

### DETAILED DESCRIPTION

The systems and methods for determining risk of a potential investment described herein may be implemented on various computing systems, including, but not limited to, desktop computers, hand-held devices, laptops or other portable computers, tablet computers, mobile phones, PDAs, Smartphones, and the like. For a firmware, and/or software implementation, the methodologies can be implemented with modules (e.g., procedures, functions, and so on) that perform the functions described herein. Any machine readable medium tangibly embodying instructions can be used in implementing the methodologies described herein. For example, software codes and programs can be stored in a memory and executed by a processing unit. Memory can be implemented within the processing unit or may be external to the processing unit. As used herein the term “memory” refers to any type of long term, short term, volatile, nonvolatile, or other storage devices and is not to be limited to any particular type of memory or number of memories, or type of media upon which memory is stored.

In another firmware and/or software implementation, the functions may be stored as one or more instructions or code on a non-transitory computer-readable medium. Examples include computer-readable media encoded with a data structure and computer-readable media encoded with a computer program. Computer-readable media may take the form of an article of manufacturer. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

It should be noted that the description merely illustrates the principles of the present subject matter. It will thus be appreciated that those skilled in the art will be able to devise various arrangements that, although not explicitly described herein, embody the principles of the present subject matter and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The manner in which the systems and methods may be implemented is explained in details with respect to the figures. While aspects of described systems and methods can be implemented in any number of different computing systems, transmission environments, and/or configurations, the embodiments are described in the context of the following exemplary system(s).

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action.

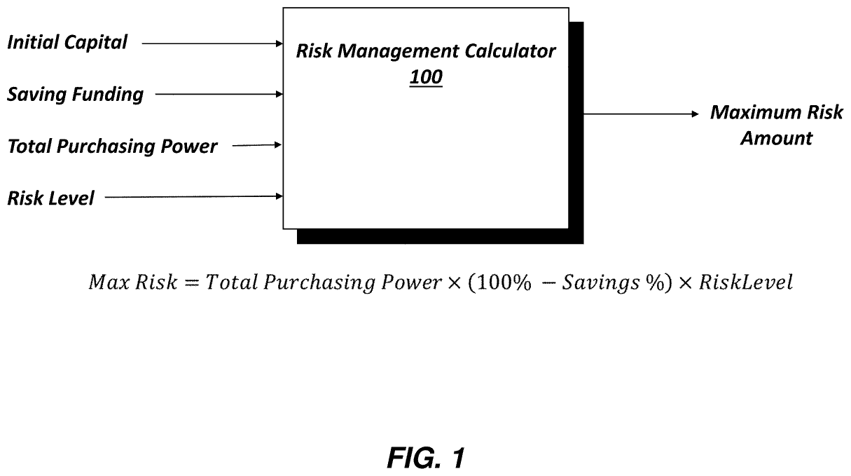

According to one aspect, a process for determining the risk associated with an investment may be determined. The system or process may first determine a maximum amount of the funds available to risk. FIG. 1 shows a schematic of the process for determining the maximum amount of risk. A user may first input an initial capital contribution, a desired risk level, and a desired savings percentage. In some configurations, a user may also input leverage or margin and the initial capital contribution may be multiplied by a factor to determine the available funds for investment based on the leverage, or the total purchasing power.

A desired risk level may be chosen by the user based on, for example, the age of the user as it is generally believed that younger investors should choose higher risk and investors closer to retirement should chose a lower risk. The desired risk is typically expressed as a percentage, for example, 1%, 2%, etc. Typically, the user may select to risk a percentage of the initial capital contributed for the model. According to the present model, an appropriate amount of risk is between 1% and 2%. Higher percentages may be used, but may not be as meaningful within the model.

In order to build its value, the model may save a percentage of the total purchasing power. An investor may select any percentage or amount to save. A savings percentage may be set for any desired level, and according to one aspect, if a user is unsure of a savings level, a default savings level may be provided, such as 20%, 30%, 40%, etc. The system may provide pre-set “modules” for users to choose from, for example, a pre-set module for a user with an age in the 20s-30s that automatically sets a savings percentage of 20% and a risk of 2%, another pre-set module for a user with an age in the 60s that automatically sets a savings percentage of 30% and a risk of 1%, etc. A user may also select to not save or protect any percentage of the initial capital contribution.

The system may then calculate a maximum amount of risk for a particular trade based on the initial capital contribution, a predetermined savings percentage, and total purchasing power (i.e., the initial capital contribution plus leverage, if any). The maximum amount of risk for a particular trade may be determined by the following equation, which may be performed by the Risk Management Calculator 100:

Max Risk=Total Purchasing Power×(100%−Savings %)×RiskLevel

Here, the total purchasing power is the initial capital multiplied by the basic margin or leverage. The basic margin may change from time to time, currently in the U.S. for many equities cases the initial margin requirement is 50%. Thus, an investor who opens an initial margin account with $7,500.00 would have a total purchasing power of $15,000 (initial contribution ×2). This initial margin requirement may vary depending on the type of market, the particular investor, etc. For some accounts and markets, no margin trading is allowed and the total purchasing power is equal to or approximately equal to the initial contribution.

To continue the example above with a total purchasing power of $15,000, and a user has selected a 30% savings, the savings may protect 30% of the total purchasing power, or $4,500.00. Thus, $10,500 is left as an amount that is subject to risk, or a risk amount.

To further continue the example above of an initial capital contribution of $7,500.00 with a 2:1 leverage and a 30% savings, if a user selects a risk rate of 1%, this becomes:

Max Risk=Total Purchasing Power×(100%−Savings %)×RiskLevel

Max Risk=($7,500×2)×(100%−30%)×0.01

Max Risk=$105.00

Expressed in another way with the total purchasing power and savings simplified to “Risk Amount”, the equation may be:

Max Risk=Risk Amount×RiskLevel

In conjunction with calculating the maximum risk based on the purchasing power, savings, and risk percentage, the system may also calculate a risk equilibrium, according to the following equation:

Risk Equilibrium=Trades Per Day×Max Risk

Again, to continue the example above, the sample calculation for risk equilibrium, where 3 trades per day are selected or allowed, may be:

Risk Equilibrium=3 Trades Per Day×$105

Risk Equilibrium=$315

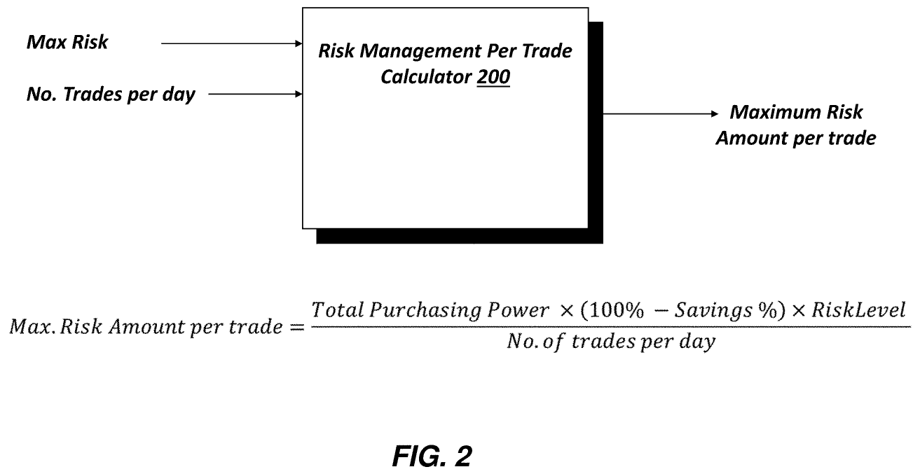

In conjunction with calculating the maximum risk based on the purchasing power, savings, and risk percentage, the system may also calculate a maximum amount that is allowed per trade. This may be accomplished by the Risk Management per Trade Calculator 200 in FIG. 2. A user may also input manually, or the system may be pre-programmed, with a desired number of trades that may be executed per day. The maximum amount of risk per trade may be calculated using the following equation:

$$Max . Risk Amount per trade = \frac{Total Purchasing Power \times ( 100 \% - Savings \% ) \times RiskLevel}{No . of trades per day}$$

Again, to continue the example above, where three trades are allowed per day, this becomes:

$$Max . Amount per trade = \frac{\$15 \text{,} 000 \times ( 70 \% )}{3}$$

$$Max . Amount per trade = \$3 \text{,} 500.00$$

It can be seen that as more trades are allowed, the maximum amount allowed per trade decreases, and as fewer trades are allowed, the maximum amount allowed per trade increases. Again, the system may have a default selection for a number of trades per day, the user may set the number of trades manually, or the number of trades may be pre-selected based on a user's profile (for example a user that trades often versus a user who trades only once per day).

After the user has input the initial capital contribution, desired risk level, leverage (if any), and desired savings, the user may then input information relating to an equity trade they wish to pursue. This may be done by a user inputting information manually, or the system may be in communication with a third party server to retrieve such information or the system may maintain up-to-date information relating to investments. Thus, a user may input, or the system may retrieve, information relating to an equity the user wishes to trade. Such information may include the current price or entry point, the current rate of exchange, etc. A user may also input, or the system may suggest, a protective stop and/or an exit.

The maximum amount allowed per trade calculated above can also be combined with a price of a potential investment, such as the price of a unit in a forex market, to determine the quantity of units that may be purchased with the maximum amount of risk allowed per trade. This may be calculated by the following equation:

Units Quantity=Maximum Amount Per Trade/Price

And to continue the example above, where the maximum per trade is $3,500 and the price has $1.11138, this becomes:

UQ=$3500.00/$1.11138

UQ=3149

The system may determine one or more of the following points relative to a potential investment, by known equations: buffer zone, spread, protective stop, entry, and/or pip risk, etc. It will be appreciated that while these calculations may be performed to give an investor additional information, not all of the equations need to be performed in order to determine and calculate the risk of the potential investment.

For example, a buffer zone may be calculated by the following known equation for a forex market:

Buffer Zone=Daily Average True Range*(10%)(Rounding Up)>4 Pips

BZ=DATR *(10%)(RUP)>4 Pips

“Pip” is used herein to represent the smallest price move that a given exchange rate makes based on market convention. Since most major currency pairs are priced to four decimal places, the smallest change is that of the last decimal point; for most pairs, this is the equivalent of 1/100 of 1%, or one basis point. For example, the smallest move that the USD/CAD currency pair can make is $0.0001, or one basis point.

It will be appreciated that other known equations may be used to calculate a buffer spread, or the system may be configured such that a buffer spread calculation is not necessary. Where the daily average true range is 76 pips, this becomes:

BZ=76 Pips*0.10 (Rounded Up)>4 Pips

7.6 rounded up=8>4 Pips

BZ=8 Pips

Spread (generally the difference between the bid and the ask price of a investment or asset) may be calculated by the following known equation for a forex market:

Spread=Spread Broker Account*10000=Rounding Up

SP=SPBA*10000=RUP

SP=0.00012*10000=1.2=2

SP=2

A protective stop may be set to protect existing gains or thwart further losses by means of a stop-loss order or limit order. A protective stop is set to activate at a certain price level and assures that an investor will make a predetermined profit or lose a predetermined amount. The protective stop is a predetermined point which marks the maximum loss a trader is willing to sustain on a single position on any trade. The protective stop may be a dollar value set by the investor, or may be predetermined by the system. For example, the system may use a trailing-stop technique. The trailing stop maintains a stop-loss order at a precise percentage below the market price (or above, in the case of a short position). The stop-loss order may be adjusted continually based on fluctuations in the market price, maintaining the same percentage below (or above) the market price. A protective stop may be calculated by the system according to the following known equation:

Protective Stop=Distal Line−Buffer Zone (Pip Value)

Stop=DL−BZ*(PV)

In a forex market where the distal line 1.10998, the buffer zone is 8 pips as calculated above, and the pip value is 10,000 (for example, for a mini-lot of 10,000 units) this becomes:

Protective Stop=1.10998−(8/10000)

Protective Stop=1.10998−0.0008

Protective Stop=1.10918

It will be appreciated that the protective stop may be calculated as shown above, or a user may enter any protective stop they desire. Protective stop strategies may vary widely depending on the investor, and thus the system may be configured to allow a user to customize a protective stop based on their own trading strategy.

The system may also calculate, according to known equations, an entry for the investment which the inventor seeks to purchase. Entry point is the price at which an investor buys an investment. Calculating an entry point may minimize investment risk and removing the emotion from trading decisions. Determining both an entry point and exit point in advance may help maximize returns. For example, the following equation may be used in a forex market to calculate entry:

Entry=Proximal Line+(Spread)(Pip Value)

It will be appreciated that other known equations to calculate entry may also be used, or a user may simply input the entry price that they believe suits their trading strategy. Where the proximal line is 1.11118, and the spread is calculated as 2 pips (from the equation above), and the pip value in the forex market is 10000 (for example, for a mini-lot), the equation for entry becomes:

Entry=1.11118+(2/10000)

Entry=1.11118+0.0002

Entry=1.11138

Similar to the protective stop above, entry need not be calculated in a particular manner, and may be manually entered by a user and set to any value they desire based on their particular trading strategy. The entry will serve as the price at which the investment or investment will be purchased.

Pip risk may also be calculated, according to known equations. In a forex market, the following known equation may be used to calculate pip risk:

Pip Risk=Entry−Protective Stop

To continue the example from above, where the entry for a forex market is calculated as $1.11138, the protective stop is calculated as $1.10918, and the pip value is 10000, the equation becomes:

PR=E−PS

PR=$1.11138−$1.10918

PR=0.0022

PR=0.0022

With a known pip risk, price, and a maximum amount that can be risked per trade, the system may calculate the risk of a given investment. The equation used to calculate risk of a potential investment may be:

$$Potential Risk = ( \frac{Maximum Amount Per Trade}{Price} ) \times Pip Risk$$

To continue with the example above, the potential risk of the investment (here, a mini-lot in a forex market with a price or entry of $1.11138, a maximum amount per trade of $3,500, and a pip risk of 22, the equation becomes:

$$Potential Risk = ( \frac{\$3 \text{,} 500}{\$1 .11138} ) \times 0.0022$$

$$Potential Risk = \$6 .92$$

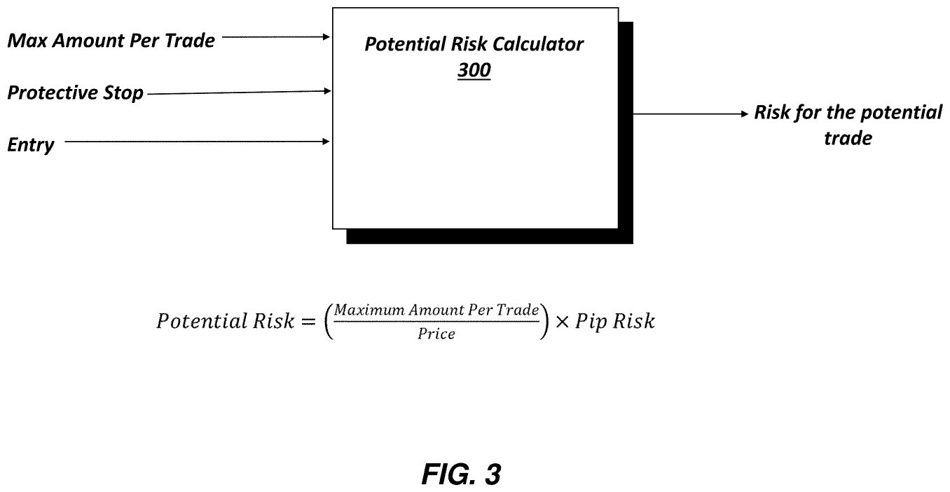

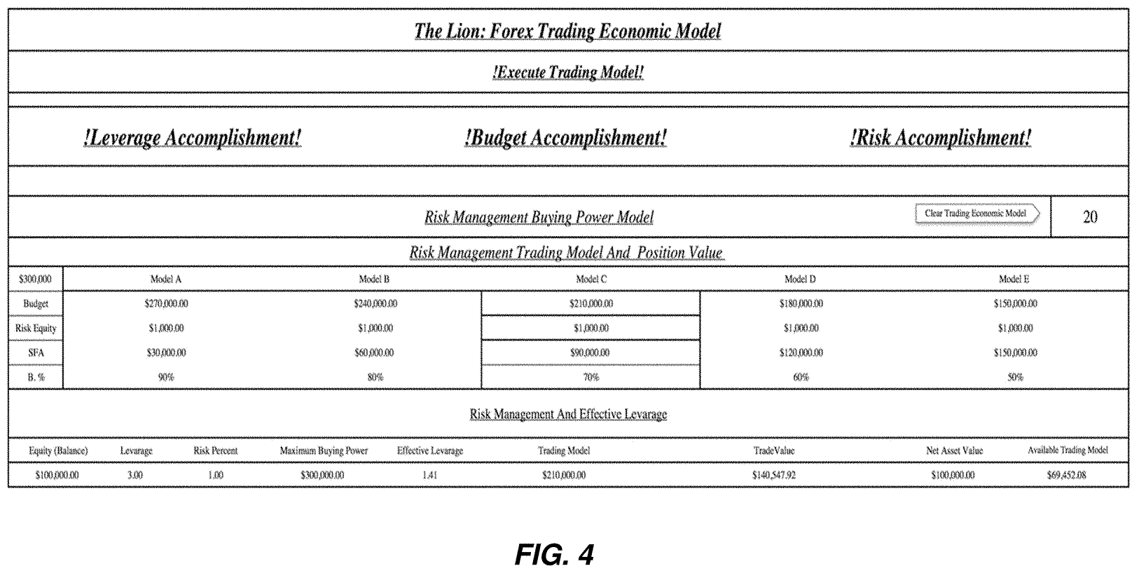

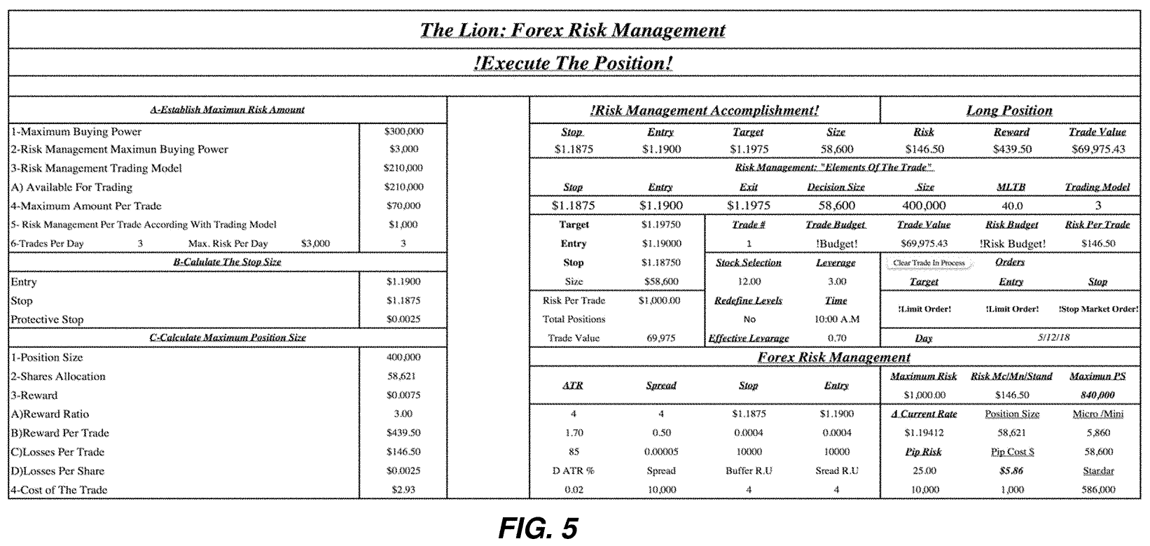

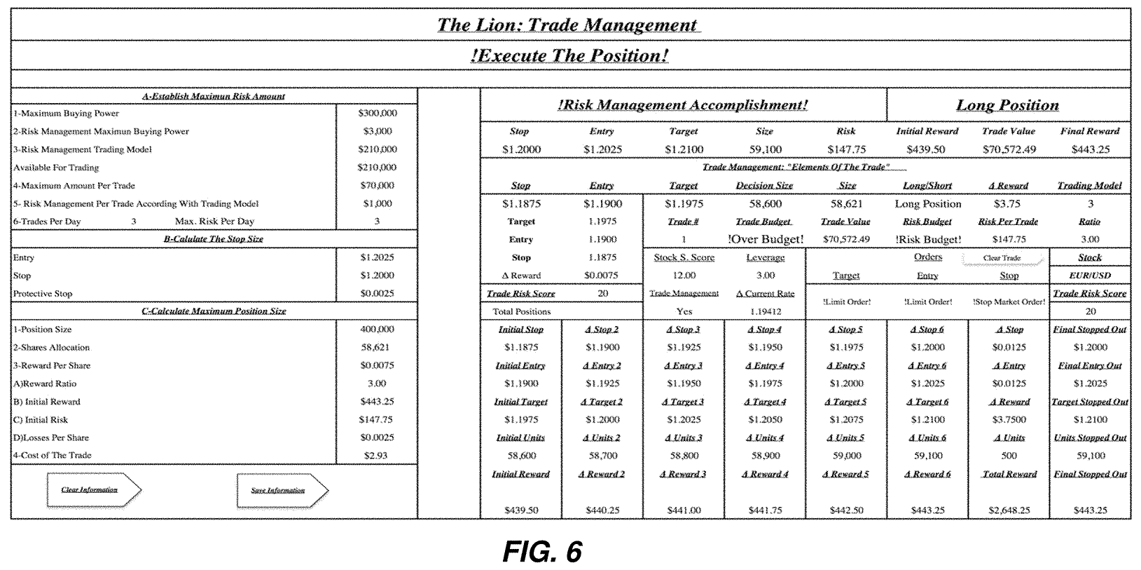

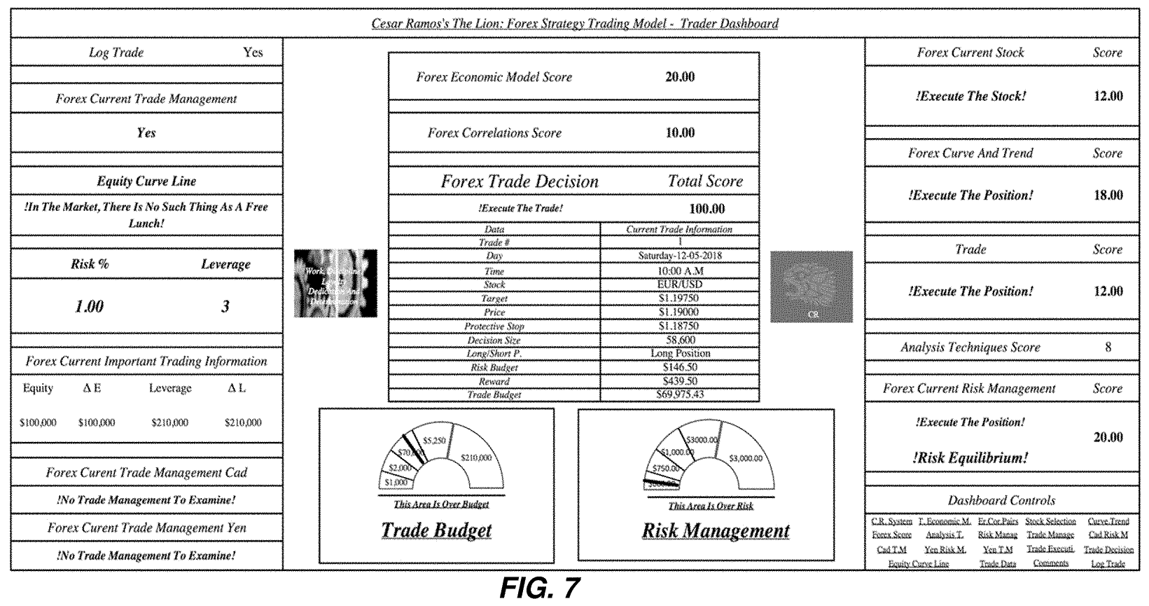

Next, the potential risk for the potential investment (as calculated by the potential risk calculator 300 shown in FIG. 3) may be compared to the calculated maximum risk amount (as calculated by the risk management calculator 100). Where the potential risk is less than the maximum risk amount, the system may indicate (either visually, audibly, etc.) that the trade is acceptable. Where the potential risk is greater than the maximum risk amount, the system may indicate that the trade is not acceptable. The system may use the following equation, which must be true in order for the system to recommend a trade:

$$Risk Trading Model = ( \frac{Maximum Amount Per Trade}{Price} ) \times Pip Risk \leq Total Purchasing Power \times ( 100 \% - Savings \% ) \times RiskLevel$$

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A process for determining a risk of a potential investment, the process comprising the steps of:
calculating a maximum amount of risk based on an initial capital contribution, a predetermined savings percentage, and a risk level;
calculating a potential risk for a potential trade of a security having a price, wherein the potential risk for the potential trade is calculated based on the maximum amount of risk, a predetermined number of trades allowed per day, a predetermined entry, and a predetermined protective stop;
comparing the maximum amount of risk to the potential risk for the potential trade; and
when the maximum amount of risk is less than the risk for the potential trade, providing instructions to execute the trade.

2. The process of claim 1, wherein the step of calculating the maximum amount of risk comprises calculating the maximum amount of risk based on a total purchasing power.

3. The process of claim 2, wherein the step of calculating the maximum amount of risk comprises calculating the maximum amount of risk according to the following equation: Max Risk=Total Purchasing Power×(100%−Savings %)×RiskLevel.

4. The process of claim 1, wherein the predetermined savings percentage is between zero and forty percent.

5. The process of claim 1, wherein the step of calculating the potential risk for the potential trade of the security comprises calculating the potential risk according to the following equation:
$$Potential Risk = ( \frac{Maximum Amount Per Trade}{Price} ) \times ( Entry - Protective Stop ) .$$

6. The process of claim 1, wherein the predetermined savings percentage is zero percent.

7. The process of claim 5, wherein the process uses the following calculation to determine a risk trading model:
$$Risk Trading Model = ( \frac{Maximum Amount Per Trade}{Price} ) \times Pip Risk \leq Total Purchasing Power \times ( 100 \% - Savings \% ) \times RiskLevel$$

8. The process of claim wherein the step of calculating the potential risk for the potential trade of the security comprises retrieving the price from a third party.

9. An investment risk system comprising a computer program product embodied in a non-transitory computer readable medium, the computer program product comprising:
computer-executable instructions for calculating a maximum amount of risk based on an input of initial capital contribution, a predetermined savings percentage, and total purchasing power;
computer-executable instructions for calculating a risk for a potential trade of a security having a price, the code for calculating the risk for the potential trade of the security calculating the risk for the potential trade of the security based on the initial capital contribution, the predetermined savings percentage, a predetermined number of trades allowed per day, the price of the security, and a predetermined protective stop;
computer-executable instructions for comparing the maximum amount of risk to the risk for the potential trade; and
computer-executable instructions for outputting an instruction to execute the potential trade when the maximum amount of risk is greater than the risk for the potential trade.

10. The system of claim 9, wherein the computer-executable instructions for calculating the maximum amount of risk comprise computer-executable instructions to calculate the maximum amount of risk according to the following equation: Max Risk=Total Purchasing Power×(100%−Savings %)×RiskLevel.

11. The system of claim 9, wherein the computer-executable instructions for calculating the risk for the potential trade of the security comprise computer-executable instructions to calculate the maximum amount of risk for the potential trade of the security according to the following equation:
$$Potential Risk = ( \frac{Maximum Amount Per Trade}{Price} ) \times ( Entry - Protective Stop )$$

12. A process for determining the risk of a potential investment, the process comprising the steps of:
calculating a maximum amount of risk based on an initial capital contribution, a predetermined savings percentage, and a risk level according to the following equation: Total Purchasing Power×(100%−Savings %)×RiskLevel;
calculating a potential risk for a potential trade of a security having a price, a predetermined number of trades allowed per day, a predetermined entry, and a predetermined protective stop according to the following equation:
$$( \frac{Maximum Amount Per Trade}{Price} ) \times Pip Risk ;$$
comparing the maximum amount of risk to the potential risk for the potential trade to determine a risk trading model according to the following equation:
$$Risk Trading Model = ( \frac{Maximum Amount Per Trade}{Price} ) \times Pip Risk \leq Total Purchasing Power \times ( 100 \% - Savings \% ) \times RiskLevel .$$

13. The process of claim 12, further comprising the step of executing the trade when the maximum amount of risk is less than the risk for the potential trade.

14. The process of claim 13, further comprising the step of executing the trade when the risk trading model is a true expression.

15. The process of claim 13, wherein the step of calculating a maximum amount of risk includes calculating the maximum amount of risk based on a leverage.

16. The process of claim 13, wherein the step of inputting, by a user, an entry price and a rate, comprises inputting, by a user, a name of the potential investment and wherein the entry price and the rate are retrieved from a third party.

17. The process of claim 15, wherein the step of calculating the potential risk for the potential trade of the security comprises retrieving the price from a third party.
